(19) United States
(12) Patent Application Publication
(10) Pub. No.: US 2023/0152346 A1
(43) Pub. Date: May 18, 2023

(54) CAPACITANCE SENSING METHOD AND ASSEMBLY

(71) Applicants: Alexey Vladimirovich Veryyaskin, Hocking (AU); Khyl John Robert McMahon, Inglewood (AU)

(72) Inventor: Alexey Vladimirovich VERYASKIN, Hocking (AU)

(21) Appl. No.: 17/988,033

(22) Filed: Nov. 16, 2022

(30) Foreign Application Priority Data
Nov. 16, 2021 (AU) 2021903674

(51) Int. Cl. G01P 15/125

(52) U.S. Cl. CPC G01P 15/125

(57) ABSTRACT

A capacitance sensing assembly comprising:
an all-pass filter including an op-amp and a first capacitor with a first electrode of the first capacitor connected to a non-inverting input of the op-amp; and
a complex impedance circuit connected between a second electrode of the first capacitor and a ground and including a variable capacitor having a terminal connected to the ground;
wherein the complex impedance circuit increases a gradient of a phase to frequency response curve of the capacitance sensing assembly relative to that of the reversed all-pass filter with the second electrode of the first capacitor connected to ground without the complex impedance circuit.

### RELATED APPLICATIONS

The present application claims priority from Australian provisional patent application No. 2021903674, filed Nov. 16, 2021, the content of which is hereby incorporated in its entirety by reference.

### TECHNICAL FIELD

The disclosed subject matter relates to a capacitance sensing assembly for use with accelerometers gravimeters, gravity gradiometers and other instruments and appliances where it is necessary to sense a physical parameter. The disclosed subject matter also relates to methods for improving sensitivity of capacitive sensing assemblies.

### BACKGROUND

Any references to methods, apparatus or documents of the prior art are not to be taken as constituting any evidence or admission that they formed, or form part of the common general knowledge.

A capacitor becomes a variable capacitor when one of its electrodes is free to move under external disturbances and another one is fixed. Their relative motion changes the value of the mutual capacitance acting as the measure of the external factors causing the disturbances. A capacitor can also change its value if electric charge is applied to one of the capacitor's electrodes. Such capacitors are called varactors or “varicaps”. By measuring this particular capacitance change it is possible to measure applied electric field. The change of the capacitive value should be translated into a measurable quantity—audio, RF, microwave, optical signals' amplitude, or phase. Phase is more desirable quantity as the primary sensing elements (capacitance-to-phase transducers) can be incorporated into interferometric read-out where one arm of an interferometer contains the variable capacitor, and another contains a fixed one. Interferometric measurements provide the most sensitive instrumentation for the detection of ultra-small phase difference in the identical carrier signals propagating through the interferometer's arms.

The ability to measure minute variations of electric capacitance leads to a large number of academic and industrial applications including fundamental research and defense.

For example, in the paper A High Precision Method for Measuring very Small Capacitance Changes by Ashkan Ashrafi and Hossein Golnabie (Review of Scientific Instruments Vol 70, No. 8 Aug. 1999) the authors describe a method for measuring very small capacitance changes based on capacitance-to-phase angle conversion. The method involves using a conventional quadrature phase sensitive detector (PSD) that provides the cotangent of the output phase in order to arrive at a linear relationship between the input capacitance and the output of the PSD. Implementation of the method is believed to be complex, and the Authors reported instabilities in their readout system that they believed were due to jitter in the main oscillator which would require a very stable oscillator to address.

Not all methods and apparatus to measure minute variations of electric capacitance allow for the use of grounded variable capacitors, which is desirable for most applications of interest. Matko and Milanovic' (Temperature-compensated capacitance—frequency converter with high resolution; Sensors and Actuators A 220 (2014) 262-269) described a temperature-compensated capacitance-to-frequency converter with a claimed resolution of +/−20 Zeptofarads (zF, 1 zF=10⁻²¹ Farad). However, this approach uses a not-grounded variable capacitor and cannot be easily adapted for, say, ultra-precision mechanical displacement measurements. Also, a high Q resonant LC-tank can be used as a simple circuit for either amplitude or phase sensitive ultra-small capacitance variation detection (Measurement of weak forces in physics experiments/V. B. Braginsky and A. B. Manukin; edited by David H. Douglass; Chicago: University of Chicago Press, 1977). Typically, it involves very high Q (Q>>100) values and represents a narrow-band detector where extremely high stability of its operation point is required.

Devices based on variable capacitors have been under development for many decades in such areas as precision accelerometry, gravimetry and gravity gradiometry. Precision accelerometers based on the MEMS technology have established their presence almost everywhere from smartphones and robotics to strategic defense applications and space missions. Consequently, there is a need for a capacitance sensing assembly that is relatively straightforward and thus compact to implement and which can measure capacitance variations.

### SUMMARY

According to a first aspect of the disclosed subject matter, there is provided a capacitance sensing assembly comprising:
an all-pass filter including an op-amp and a first capacitor with a first electrode of the first capacitor connected to a non-inverting input of the op-amp; and
a complex impedance circuit connected between a second electrode of the first capacitor and a ground and including a variable capacitor having a terminal connected to the ground;
wherein the complex impedance circuit is configured to increase a gradient of a phase to frequency response curve of the capacitance sensing assembly relative to that of the all-pass filter with the second electrode of the first capacitor connected to ground without the complex impedance circuit.

In an embodiment the complex impedance circuit comprises a resonant circuit wherein the variable capacitor comprises a capacitor of the resonant circuit.

In an embodiment the resonant circuit comprises an inductor-capacitor tank circuit.

In an embodiment the variable of the resonant circuit is implemented with a capacitance magnifier circuit to thereby simulate a larger capacitance value variable capacitor with a smaller capacitance value variable capacitor.

In an embodiment the complex impedance circuit comprises a negative capacitor circuit.

In an embodiment the negative capacitor circuit includes a second capacitor in parallel with the negative capacitor sensor.

According to a further aspect there is provided a capacitor sensing assembly wherein a variable capacitor thereof comprises a component of a resonant circuit.

In another aspect there is provided a capacitor sensing assembly wherein a variable capacitor thereof comprises a component of a capacitor multiplier circuit.

In a further aspect there is provided a capacitor sensing assembly wherein a variable capacitor thereof comprises a component of a negative capacitance circuit.

In a further aspect there is provided a method for improving sensitivity of a capacitor sensing assembly, the method comprising:
replacing a variable capacitor (“first variable capacitor”) of the capacitor sensing assembly with a capacitor multiplier circuit, the capacitor multiplier circuit including a variable capacitor (“second variable capacitor”) wherein the second variable capacitor has a smaller capacitance than the first variable capacitor.

In an embodiment the capacitor multiplier circuit forms part of a resonant circuit.

In another aspect there is provided a method for improving sensitivity of a capacitor sensing assembly having a first capacitor, the method comprising:
connecting a negative capacitance in series with the first capacitor to thereby produce an effective variable capacitance having a capacitance value less than the first capacitor.

### BRIEF DESCRIPTION OF THE DRAWINGS

Preferred features, embodiments and variations the subject matter disclosed herein may be discerned from the following Detailed Description which provides sufficient information for those skilled in the art to perform the disclosed subject matter. The Detailed Description is not to be regarded as limiting the scope of the preceding Summary of the disclosed subject matter in any way. The Detailed Description will make reference to a number of drawings as follows:

FIG. 1 is a circuit diagram of a capacitively grounded all-pass filter.

FIG. 2 is a graph of the phase response of the all-pass filter of FIG. 1 for three sets of component values.

FIG. 3 shows the circuit of FIG. 2 with a complex impedance circuit block inserted between the capacitor and ground.

FIG. 4 shows a capacitive sensing circuit wherein the complex impedance circuit block comprises a tank circuit.

FIG. 5 is a phase response graph for the circuit of FIG. 4 over a range of frequencies.

FIG. 6 is a gain response graph for the circuit of FIG. 4 over the range of frequencies.

FIG. 7 is an oscilloscope trace of the phase response graph of the circuit of FIG. 4 for a set of component values.

FIG. 8 is an oscilloscope trace of the gain response graph of the circuit of FIG. 4 for the set of component values.

FIG. 9 is circuit of an exemplary capacitance magnifier.

FIG. 10 is a circuit that is simulated by the capacitance magnifier circuit of FIG. 9.

FIG. 11 is a capacitive sensing circuit wherein the complex impedance circuit block comprises the capacitance magnifier circuit.

FIG. 12 is a capacitive sensing circuit wherein the complex impedance circuit block comprises a negative capacitor.

FIG. 13 is a capacitive sensing circuit wherein the negative capacitor is implemented with an op-amp circuit.

FIG. 14 is a capacitive sensing circuit wherein the complex impedance circuit includes a bias capacitor.

### DETAILED DESCRIPTION OF PREFERRED EMBODIMENTS

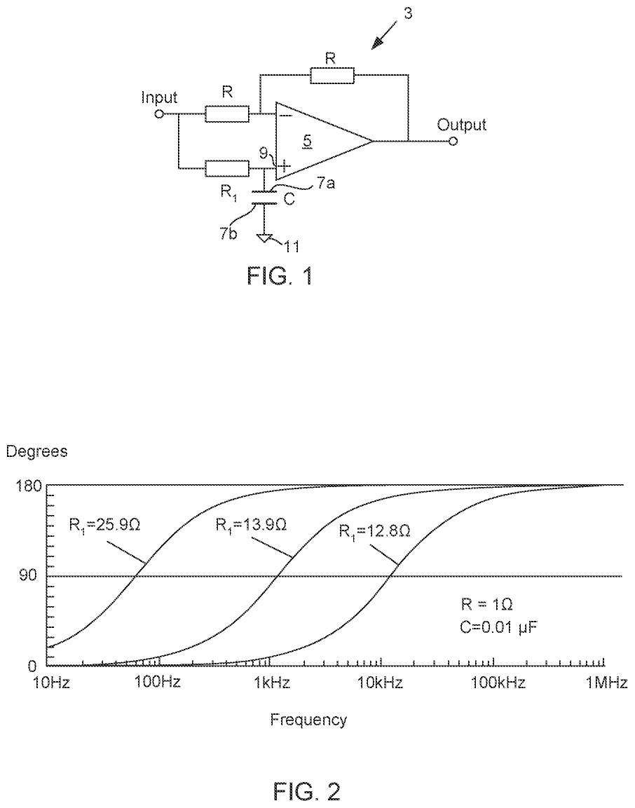

FIG. 1 is a circuit schematic of an all-pass filter 3 which has a capacitor C connected by its electrode 7a to the non-inverting input 9 of the op-amp 5 and by its opposite electrode 7b to ground 11. All-pass filters have no amplitude roll-off properties. That is, the magnitude of the signal at the output of an all-pass filter does not change with change in frequency of the input of the all-pass filter.

However, the all-pass filter exhibits phase-shift properties.

The transfer function of all-pass filter 3 is:

$$H ( ω ) = - \frac{1 - j ω {R}_{1} C}{1 + j ω {R}_{1} C} \qquad ( 1 )$$

so that the amplitude versus frequency response is flat.

The phase shift is:

φ=−2 arctan(ωR₁C) (2)

FIG. 2 is a graph illustrating the phase difference to frequency relationship of the all-pass filter 3 for R=1Ω, C=0.01 μF and three different values of R1.

The inventor has recognized that all-pass filter 3 is suited to capacitive sensing since it makes use of a grounded capacitor, which can be implemented as a moving plate capacitor or other variable type capacitor that requires grounding. Capacitive sensing typically uses a grounded capacitor. Unfortunately, the Inventor has found that the capacitance-to-phase conversion that is exhibited is not suitable for detecting small changes in capacitance, for example due to small capacitor electrode movements. This can be understood by contemplating the phase shift relationship set out in Eqn (2) and illustrated in the graph of FIG. 2. In particular, a change in the size of C in Eqn (2) does not make a very significant difference to the change in phase shift. Consequently, whilst the topology of the circuit of FIG. 1 is promising as a starting point for building a capacitive sensor, it is of insufficient sensitivity for the very fine sensing that is desired. The Inventor has striven to provide an improvement that can increase the sensitivity so that it is possible to detect very small capacitance variations and thus the physical perturbations that cause them and which it is desired to be able to measure.

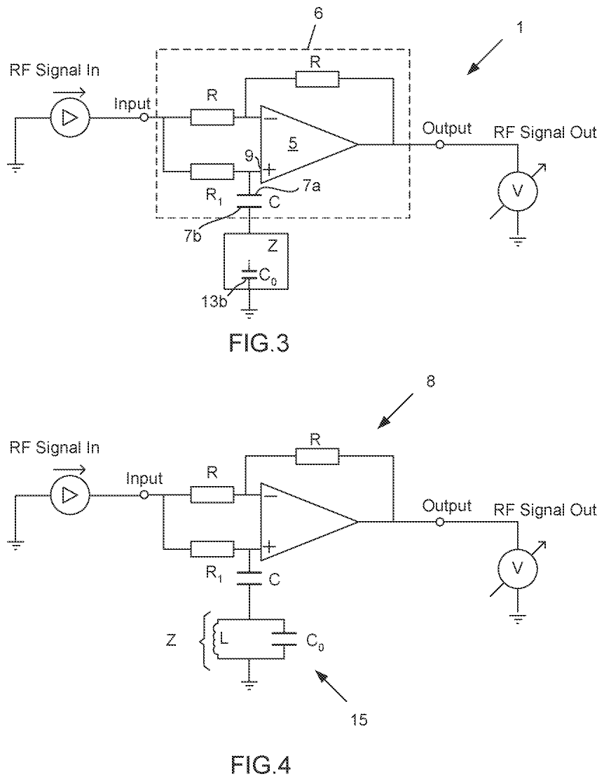

In overview, in a first embodiment a capacitance sensing assembly 6 (FIG. 3) is provided which includes a typical all-pass filter 3. The all pass filter 3 includes an op-amp 5 and a first capacitor C with a first electrode 7a of the first capacitor C connected to a non-inverting input 9 of the op-amp 5. A complex impedance circuit Z is connected between a second electrode 7b of the first capacitor C and ground 11. The complex impedance circuit Z includes a variable capacitor C₀ having an electrode 13b connected to the ground 11. The complex impedance circuit Z is configured to increase a gradient m of a phase-to-frequency response curve of the capacitance sensing assembly at a predetermined operating point OP. The complex impedance circuit Z increases the gradient m relative to that of the all-pass filter 3, with the second electrode of the first capacitor C connected to ground, as shown in FIG. 1.

In an embodiment of a capacitance sensing assembly 8 that is illustrated in FIG. 4, the complex impedance circuit Z comprises a resonant circuit 15 and the variable capacitor C₀ comprises the capacitor C₀ of the resonant circuit 15.

In the capacitive sensing circuit 8 of FIG. 4 the resonant circuit 15 comprises an inductor-capacitor tank circuit which includes an inductor L in parallel with the variable capacitor C₀.

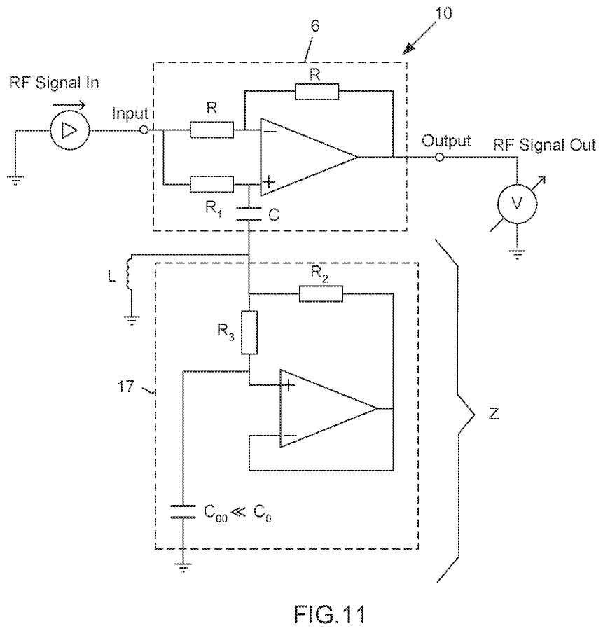

With reference to the capacitance sensing assembly 10 of FIG. 11, the variable capacitor C₀ of the resonant circuit 15 (of FIG. 4) may be implemented with a capacitance magnifier circuit 17 to thereby simulate a larger capacitance value variable capacitor with a smaller capacitance value variable capacitor C₀₀.

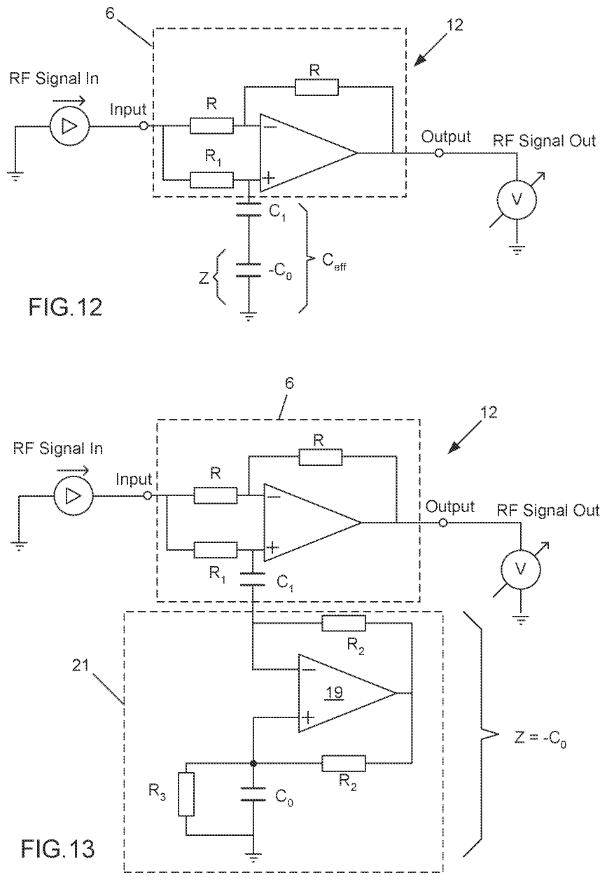

In another embodiment, a capacitance sensing assembly 12 (FIG. 12), the complex impedance circuit Z comprises a negative capacitor −C₀. As shown in FIG. 13, the negative capacitor −C₀ may implemented with a negative capacitor simulating circuit 21 including an op-amp 19 and resistors, R2, R3 and variable capacitor C₀.

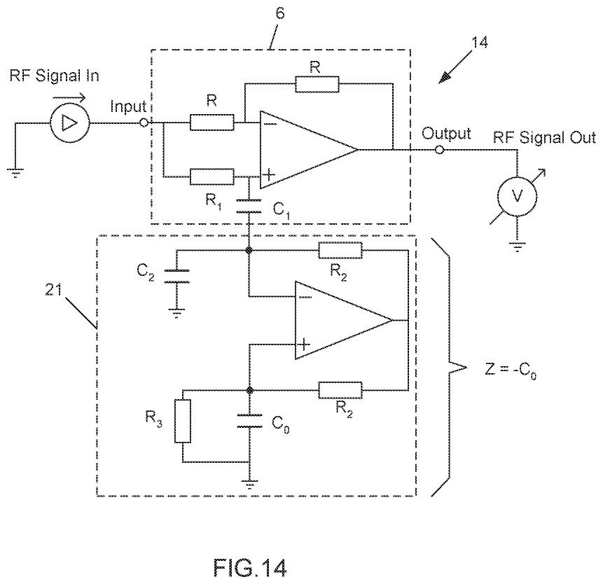

In a further embodiment illustrated in FIG. 14, the capacitance sensing assembly the negative capacitor circuit includes a second capacitor C2 in parallel with the negative capacitor circuit for reducing a fixed (bias) portion of the capacitance of the variable capacitor C₀.

Referring now again to FIG. 4 circuit 8 incorporates a complex impedance circuit block Z in the form of a low-Q resonant tank circuit 15 comprising parallel inductor L and variable capacitor C₀.

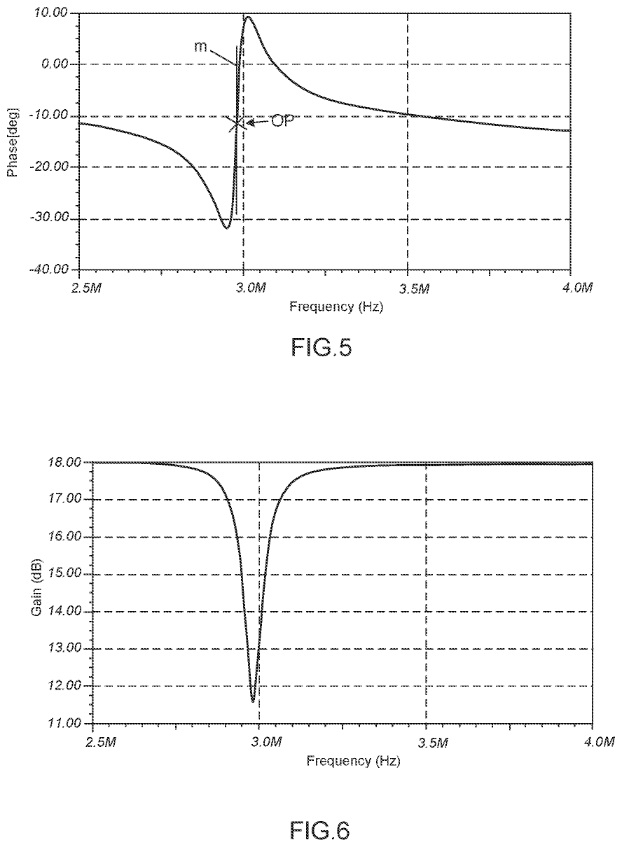

FIGS. 5 and 6 are circuit simulation plots showing respectively the phase shift response and the magnitude response of the capacitive sensing circuit 8 at a predetermined operating point OP for a fixed carrier frequency.

It will be observed that the addition of the tank circuit 15 makes the phase curve very steep in the vicinity of the fixed carrier frequency. The Inventor has found that a very small change in the value of the variable capacitor C₀, for example as might be caused by minute change in distance between the electrodes of C₀ due to a physical parameter being sensed, causes a large change in the phase response as indicated by the very steep gradient of tangent m of the graph at OP.

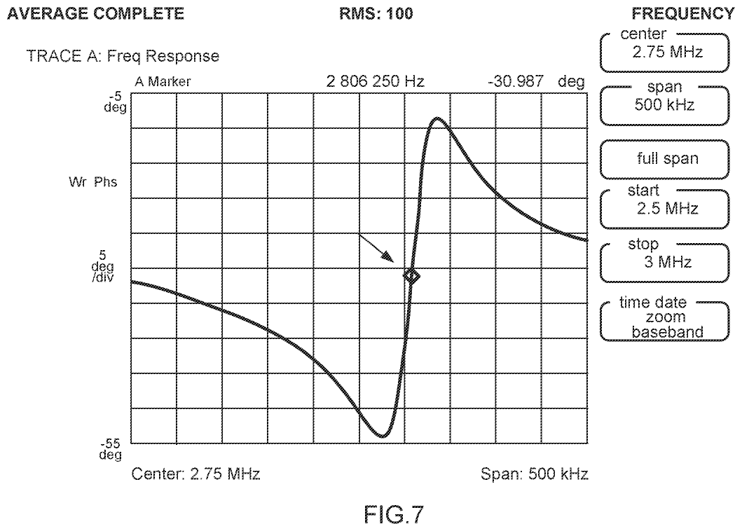

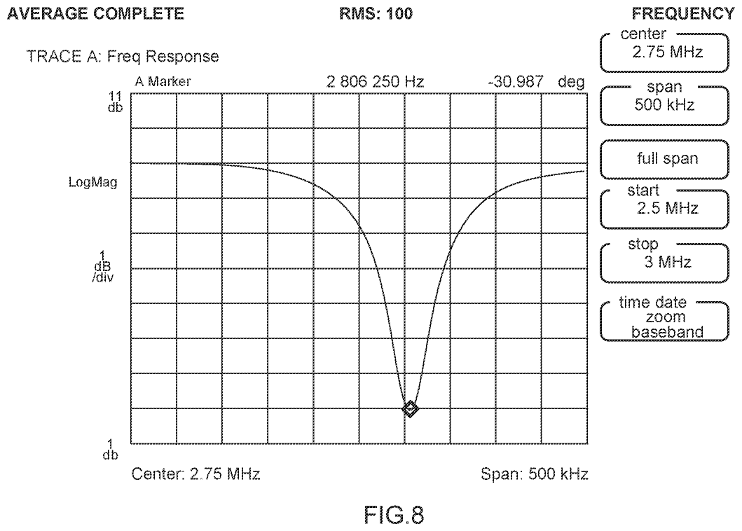

FIGS. 7 and 8 are oscilloscope traces for the sensing circuit of FIG. 4 where the component values are as follows:
R=100 Ohm, R1=220 Ohm
C=6-30 pF tuneable airgap capacitor
L=100 μH, high quality factor inductor
C0˜10-15 pF
and the RF signal carrier frequency is 2.806 MHz.

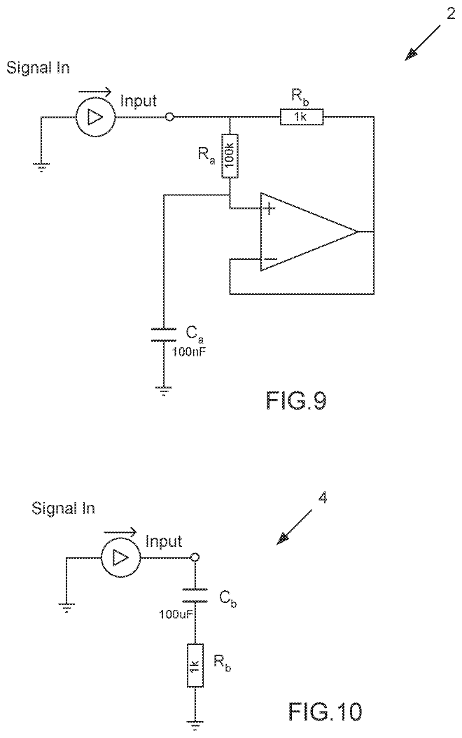

Referring now to FIG. 9, a capacitor multiplier circuit 2, for example as is sometimes used to filter ripple in the output an AC-DC converter, is illustrated. The capacitor multiplier circuit 2 of FIG. 9 uses an op-amp and a small capacitor Cₐ to simulate a much larger capacitor C_{b} as shown in the circuit 4 of FIG. 10. Capacitor multiplier circuit 2 simulates circuit 4. The resistor Rb in circuit 2 is the same size as the resistor Rb in the circuit 4 being simulated (FIG. 10), but the capacitor Cₐ in FIG. 9 is only one hundredth the size of the capacitor C_{b} in FIG. 10.

The operation of the capacitor multiplier circuit 2 of FIG. 9 will now be explained. Current flows from the input source through Rₐ to the capacitor (Cₐ). Since Rₐ is 100 times larger than R_{b}, there is 1/100th the current through it into the capacitor Cₐ. For a given input voltage, the rate of change in voltage in Cₐ is the same as in C_{b}, because C_{b} has 100 times the capacitance to make up for 1/100th the current.

Therefore, the voltages across Cₐ and C_{b} are the same, but the currents are not. The op-amp in FIG. 9 causes the negative input to be held at the same voltage as the voltage across Cₐ. Consequently, R_{b} of FIG. 9 has the same voltage across it as R_{b} of FIG. 10, and therefore the same current.

FIG. 11 depicts a capacitance sensing assembly 10 according to a further embodiment wherein the variable capacitor C₀ of the tank circuit of the capacitive sensing circuit of FIG. 4 has been replaced with capacitor multiplier circuit 17 that uses a variable capacitor C₀₀ which, according to the selection of R3 and R2, is a fraction of C₀. Consequently, the capacitance sensing assembly of FIG. 11 has improved sensitivity compared to the first embodiment 8 of FIG. 4.

FIG. 12 depicts an equivalent circuit of a further embodiment of a capacitive sensing circuit 12 where the effective capacitance is:

$${C}_{e f f} = \frac{{C}_{1} \vert {C}_{0} \vert}{\vert {C}_{0} \vert - {C}_{1}} \qquad ( 3 )$$

If the difference between the positive and the negative capacitors, connected in series, is small, this can magnify the effective capacitance by orders of magnitude. In turn, this will magnify any change in the negative grounded capacitor by the same amount. That what we want in order to increase the effectiveness of the capacitive sensing. This will also allow for a reasonably low frequencies to be used for further signal processing, compared to that of microwave case. The power required to feed the circuit is negligible compared to the latter one. This type of sensing perfectly fits into a Mach-Zehnder interferometry and flip-flop phase detectors in which an overall sensing capacitance Cₛ is reduced to a value of C₁+(−C₀) where −C₀ is a negative capacitance.

The negative capacitance is implemented using a negative capacitance op-amp circuit 21 as shown in FIG. 13. Negative capacitance op-amp circuits are analogous to the more widely known negative resistance circuits and are discussed for example at: https://en.wikibooks.org/wiki/Circuit_Idea/Revealing_the_Mystery_of_Negative_Impedance#Op-amp_implementation (retrieved Jul. 11, 2021).

FIG. 14 depicts another embodiment wherein the constant part of the variable capacitor (−CO) (its bias) is reduced by placing capacitor C2 in parallel with the −CO circuit to highlight its variable part: −C0+C2−ΔC0, C2<|C0|

The Inventor believes that various of the embodiments discussed herein provide a low cost and size capacitance sensing assembly for measuring capacitance variations in moving plate capacitors as low as <10-20 Farad (0.00001 femtoFarad). Consequently, very small movements of the electrode, e.g. the grounded electrode of the variable capacitor may be sensed and so correspondingly, very small movements and accelerations of physical objects to which the grounded electrode is attached. Also, a very small electric field of much less than a microvolt per metre magnitude can be detected if the variable capacitor comprises a varicap.

In compliance with the statute, the subject matter disclosed herein has been described in language more or less specific to structural or methodical features. The term “comprises” and its variations, such as “comprising” and “comprised of” is used throughout in an inclusive sense and not to the exclusion of any additional features. It is to be understood that the subject matter disclosed herein is not limited to specific features shown or described since the means herein described comprises preferred forms of putting the disclosed subject matter into effect. The disclosed subject matter is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment herein is meant to be illustrative only and is not meant to be limiting. Therefore, it should be appreciated that various other changes and modifications can be made to any embodiment described without departing from the spirit and scope of the subject matter disclosed herein.

1. A capacitance sensing assembly comprising:
an all-pass filter including an op-amp and a first capacitor with a first electrode of the first capacitor connected to a non-inverting input of the op-amp; and
a complex impedance circuit connected between a second electrode of the first capacitor and a ground and including a variable capacitor having a terminal connected to the ground;
wherein the complex impedance circuit is configured to increase a gradient of a phase to frequency response curve of the capacitance sensing assembly at a predetermined operating point, relative to that of the all-pass filter with the second electrode of the first capacitor connected to ground without the complex impedance circuit.

2. The capacitance sensing assembly of claim 1, wherein the complex impedance circuit comprises a resonant circuit wherein the variable capacitor comprises a capacitor of the resonant circuit.

3. The capacitance sensing assembly of claim 2, wherein the resonant circuit comprises an inductor-capacitor tank circuit.

4. The capacitance sensing assembly of claim 2, wherein the variable capacitor of the resonant circuit is implemented with a capacitance magnifier circuit to thereby simulate a larger capacitance value variable capacitor with a smaller capacitance value variable capacitor.

5. The capacitance sensing assembly of claim 1, wherein the complex impedance circuit comprises a negative capacitor circuit.

6. The capacitance sensing assembly of claim 5, wherein the negative capacitor circuit includes a second capacitor in parallel with the negative capacitor circuit.

7. A method for improving sensitivity of a capacitor sensing assembly, the method comprising:
replacing a variable capacitor (“first variable capacitor”) of the capacitor sensing assembly with a capacitor multiplier circuit, the capacitor multiplier circuit including a variable capacitor (“second variable capacitor”) wherein the second variable capacitor has a smaller capacitance than the first variable capacitor.

8. The method of claim 7, wherein the capacitor multiplier circuit forms part of a resonant circuit.

9. A method for improving sensitivity of a capacitor sensing assembly having a first capacitor, the method comprising:
connecting a negative capacitance in series with the first capacitor to thereby produce an effective variable capacitance having a capacitance value less than the first capacitor.
